(19) United States
(12) Patent Application Publication
(10) Pub. No.: US 2011/0120844 A1
(43) Pub. Date: May 26, 2011

(54) Electrical switch

(75) Inventors: Ralf Hoffmann, Berlin (DE); Matthias Kroeker, Mittenwalde-Ragow (DE); Udo Gabel, Berlin (DE)

(73) Assignee: Tyco Electronics Amp GmbH, Bensheim (DE)

(21) Appl. No.: 12/927,731

(22) Filed: Nov. 22, 2010

(30) Foreign Application Priority Data
Nov. 24, 2009 (DE) 102009047080.8

(51) Int. Cl. H01H 1/06

(52) U.S. Cl. 200/275

(57) ABSTRACT

A switch for switching an electrical load comprises a contact chamber in which a first contact member, a second contact member and a movable contact bridge are arranged. The contact chamber is arranged in a mounting support. The contact chamber comprises a ceramic material and the mounting support comprises a plastics material.

### BACKGROUND

The invention relates to a switch for switching an electrical load.

Switches for opening and closing electrical connections are known from the prior art in a number of configurations. Contactors and relays are used for switching high and very high electrical loads. Switches of this type comprise contact chambers, on which high requirements are placed as regards possible operating temperatures, permissible internal pressures, electrical insulating capability and arc resistance.

Conventionally, contact chambers of this type are manufactured from plastics material, resulting in advantages as regards production and assembly. For example, the resilient properties of the plastics material can be exploited to produce press-in or other resilient connections. However, the heat resistance and electrical insulation capability of plastics materials are limited. Flame impingement by an arc, which occurs when the electrical load is disconnected, can lead to combustion (oxidation) of the surface of the plastics material, greatly reducing the insulation resistance.

An alternative involves manufacturing the contact chamber of the switch from a ceramic material. Materials of this type have a very favourable resistance to arc flame impingement, are practically incapable of oxidation, and also have a very favourable heat resistance. However, ceramic materials only have a very low resilience, and this means that cost-effective press-in or snap-in connections cannot be used. It is also difficult to make the contact chamber pressure-tight, as is conventional for high-load switches.

The object of the invention is to provide an improved switch for switching an electrical load. This object is achieved by a switch having the characterising features of claim 1. Preferred developments are specified in the dependent claims.

### SUMMARY

According to the invention, a switch for switching an electrical load comprises a contact chamber in which a first contact member, a second contact member and a movable contact bridge are arranged. Meanwhile, the contact chamber itself is arranged in a mounting support. The contact chamber comprises a ceramic material and the mounting support comprises a plastics material. In this switch, the advantages of a high resistance of a ceramic contact chamber are combined with the advantageous resilient properties of a mounting support made of plastics material. This provides favourable electrical properties and simple mounting.

It is expedient for the contact bridge to be able to assume a first position, in which the contact bridge conductively connects the first contact member and the second contact member, and a second position, in which the first contact member and the second contact member are mutually electrically insulated.

Preferably, the switch comprises a solenoid actuator, which is configured to switch the contact bridge between the first position and the second position. Advantageously, a solenoid actuator of this type may be controlled automatically and is also capable of exerting high forces.

Particularly preferably, the contact bridge assumes the second position when there is no current to the solenoid actuator. Advantageously, in this way the switch is safely open if the supply voltage fails. Moreover, the switch does not take up any power when open.

In one embodiment, in the second position, the contact bridge is not in conductive contact either with the first contact member or with the second contact member. Advantageously, a double-breaking configuration of this type of the switch is particularly safe.

According to one embodiment of the switch, the contact chamber comprises a first aperture and a second aperture. In this case, the first contact member extends through the first aperture and the second contact member extends through the second aperture. Moreover, the mounting support comprises a first opening and a second opening. The first contact member extends through the first opening and the second contact member extends through the second opening. Advantageously, in this way the contact members are accessible from the outside.

In a preferred embodiment, the switch comprises a housing in which the mounting support and the contact chamber are arranged. Advantageously, the shape of the housing may be adapted to the specific intended use of the switch.

It is expedient for a metal cup to be provided in the housing. In this case, the mounting support and the contact chamber are arranged in the cup.

Particularly preferably, the first contact member and the second contact member are fixed in the housing a filling compound. Advantageously, this provides a robust configuration of the switch which is cost-effective to manufacture.

In a development of the switch, the housing is tightly sealed by the filling compound. Advantageously, in this case the switch is able to switch high electrical loads.

According to one embodiment of the switch, the contact chamber comprises a base part and a cap.

Preferably, the base part of the contact chamber comprises a peripheral plug and the cap of the contact chamber comprises a peripheral groove, the groove being engaged with the plug. Advantageously, in this way an internal pressure which builds up when the electrical load is disconnected is diverted from the walls of the base part of the contact chamber onto the cap of the contact chamber, preventing the walls of the contact chamber from breaking.

Preferably, the base part and/or the cap of the contact chamber are produced by injection moulding. Advantageously, this makes a cost-effective configuration of the switch possible.

In a development of the switch, at least one permanent magnet is arranged between the contact chamber and the mounting support. Advantageously, this permanent magnet, as a blow magnet, causes an arc occurring during the disconnection of the electrical load to be blown out and extinguished.

In a preferred configuration of the switch, at least two permanent magnets are arranged between the contact chamber and the mounting support and are mutually separated by intermediate walls at least in part. Advantageously, this facilitates the insertion of the permanent magnets and provides precise positioning of the permanent magnets.

In a further preferred configuration of the switch, the mounting support comprises a circular disc-shaped base plate, on which two mutually parallel side walls are placed. In this case, the contact chamber is arranged in a chamber receiving region provided between the side walls. Advantageously, in this case the contact chamber can be held in the mounting support by a resilient snap-in connection.

In the following, the invention is described in greater detail by way of drawings, in which like reference numerals are used for like or functionally similar parts.

### BRIEF DESCRIPTION OF THE DRAWINGS

FIG. 1 is a perspective view of a switch;

FIG. 2 is a first section through the switch;

FIG. 3 is a second section through the switch;

FIG. 4 is a perspective view of a base part of a contact chamber;

FIG. 5 is a perspective view of a cap of the contact chamber;

FIG. 6 is a perspective view of a mounting support;

FIG. 7 is an exploded view of the mounting support and the contact chamber; and

FIG. 8 is a perspective view of the mounting support and the contact chamber when assembled.

### DETAILED DESCRIPTION

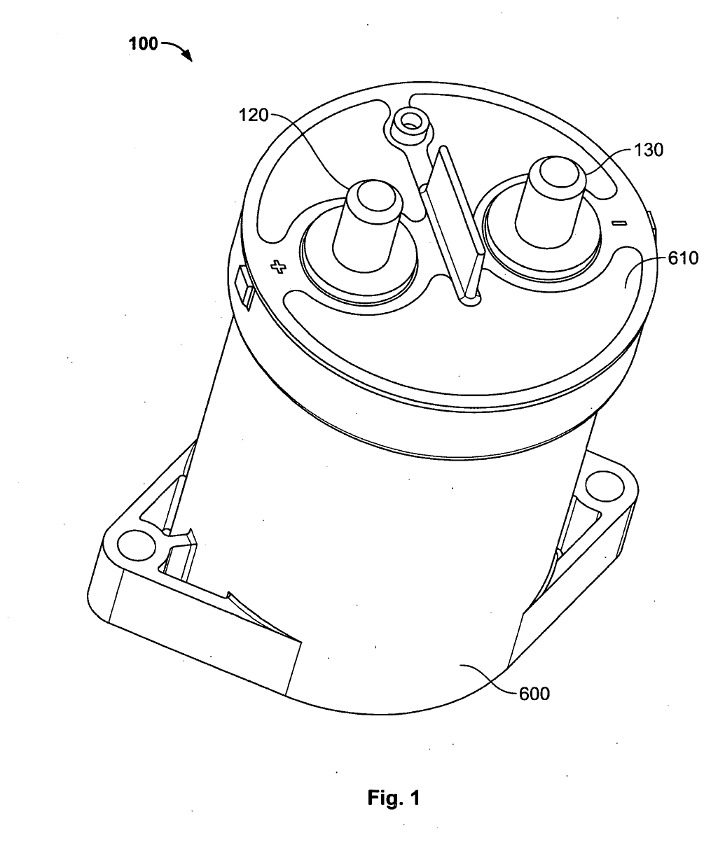

FIG. 1 is a perspective view of a switch 100 for switching an electrical load. The switch 100 may also be referred to as a relay or a contactor. The switch 100 comprises a housing 600 having a cover disc 610. The housing 600 and the cover disc 610 may consist of plastics material or another material.

A first contact member 120 and a second contact member 130 are guided through two apertures in the cover disc 610. The first contact member 120 and the second contact member 130 consist of an electrically conductive material, for example a metal, and are provided to be connected to electrical contacts of an electrical load which is to be switched, for example an electric motor.

The switch 100 is provided to open and close an eleptrical connection between the first contact member 120 and the second contact member 130. In this way, the switch 100 may for example be used to switch the power supply of an electric motor. When it is closed, high currents of for example more than 100 A at voltages of more than 850 V can flow between the first contact member 120 and the second contact member 130.

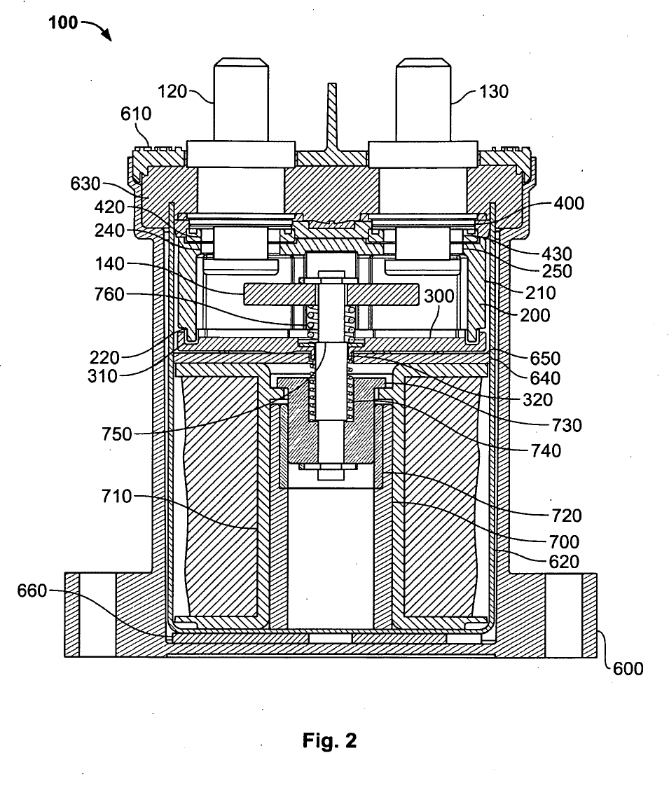

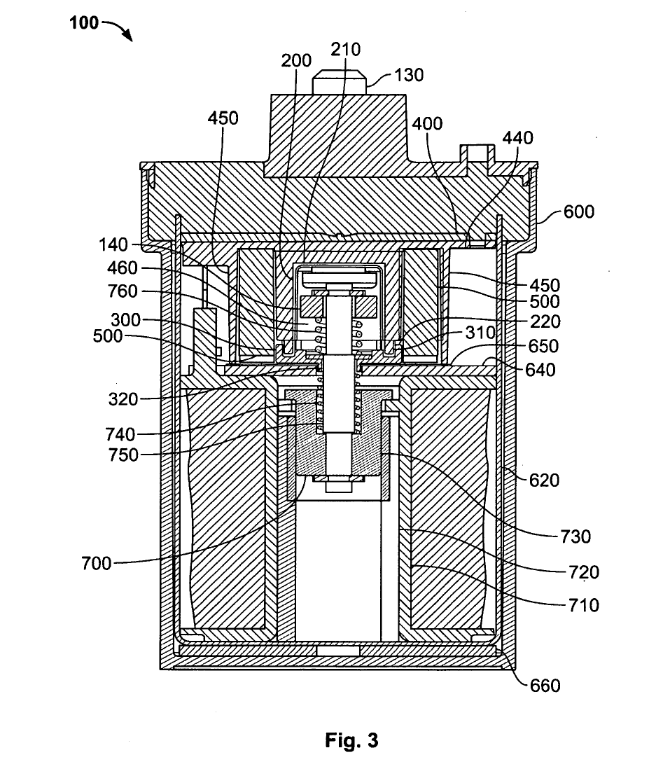

FIG. 2 is a section through the switch 100. In this case, the section extends through the first contact member 120 and the second contact member 130. FIG. 3 is a further section through the switch 100, the switch extending between the first contact member 120 and the second contact member 130 perpendicular to the plane of the section of FIG. 2.

The housing 600 of the switch 100 is formed substantially as a hollow cylinder and is open at one side. The open end of the hollow cylindrical housing 600 is sealed by the substantially circular disc-shaped cover disc 610. A cup 620 is arranged inside the housing 600, and is also formed as a hollow cylinder and open at one side. The cup 620 thus lines the housing 600. The cup 620 consists of an electrically conductive material, for example a metal, and provides the electromagnetic reflux of the solenoid actuator 700. At the end faces, a metal disc 660 may be arranged between the cup 620 and the housing 600.

The space enclosed by the cup 620 within the housing 600 is substantially divided in two in the longitudinal direction of the housing 600. A solenoid actuator 700 is arranged in a lower portion remote from the aperture, which is sealed by the cover disc 610, of the housing 600. The portion comprising the solenoid actuator 700 of the space within the cup 620 is separated by a circular disc-shaped disc 640 from an upper portion in which a mounting support 400 and a contact chamber 200 are arranged. The disc 640 separating the two portions may furthermore comprise an insulation film 650 which electrically insulates the two portions within the cup 620 from one another. The insulation film 650 may for example be arranged on the side of the disc 640 facing the mounting support 400 and the contact chamber 200.

The first contact member 120 and the second contact member 130 extend parallel to one another through apertures in the cover disc 610, through a first opening 420 and a second opening 430 respectively in a base plate 440 of the mounting support 400, and through a first aperture 240 and a second aperture 250 respectively in a base part 210 of the contact chamber 200, and end inside the contact chamber 200. The first contact member 120 thus extends from outside the switch 100 through an aperture in the cover disc 610, the first opening 420 in the mounting support 400 and the first aperture 240 of the contact chamber 200. The second contact member 130 extends from outside the switch 100 through the second aperture of the cover disc 610, the second opening 430 of the mounting support 400 and the second aperture 250 of the contact chamber 200.

A contact bridge 140 is movably arranged in the contact chamber 200. The contact bridge 140 consists of an electrically conductive material, for example a metal. The contact bridge 140 may for example be in the shape of a planar cuboid. The contact bridge 140 is movably arranged in such a way that it can be brought into contact with the first contact member 120 and the second contact member 130 simultaneously so as to produce an electrical connection between the first contact member 120 and the second contact member 130. The contact bridge 140 can also be moved away from the first contact member 120 and the second contact member 130 in such a way that the electrical connection between the first contact member 120 and the second contact member 130 is broken.

For moving the contact bridge 140, the contact bridge 140 is rigidly connected to a guide rod 750, which is formed substantially cylindrically and is guided through an aperture in the contact bridge 140. The guide rod 750 extends parallel to the extension direction of the contact members 120, 130 and of the housing 600 and is aligned on a longitudinal axis of the housing 600. The guide rod 750 extends through an opening 320 in a cap 300 of the contact chamber 200 and through an opening in the disc 640 and the insulation film 650 into the region of the solenoid actuator 700.

The solenoid actuator 700 comprises a coil form 710 having a wire winding. The winding of the coil form 710 can be loaded with a voltage from outside to produce a magnetic field within the coil form 710. A guide bushing 720 in the shape of a cylindrical shell is arranged in the region enclosed by the coil form 710. An armature 730 is movably arranged inside the guide bushing 720. The armature 730 comprises a central hole through which the guide rod 750 is guided. The end of the guide rod 750 remote from the contact bridge 140 is rigidly connected to the armature 730.

A return spring 740 formed as a flat spiral spring extends around the guide rod 750 in the region between the disc 640 and the armature 730. A first end of the return spring 740 is supported on the disc 640, and a second end of the return spring 740 is supported on the armature 730. In the region between the contact bridge 140 and the cap 300 inside the contact chamber 200, the guide rod 750 extends through an overshoot spring 760 which is also formed as a flat spiral spring. A first end of the overshoot spring 760 is supported on the contact bridge 140, and a second end of the overshoot spring 760 is supported on the cap 300 on the contact chamber 200.

The spring forces of the return spring 740 and the overshoot spring 760 are designed so that if there is no current flowing in the windings of the coil form 710, i.e. if there is no magnetic field in the solenoid actuator 700, the guide rod 750 supporting the contact bridge 140 assumes a position in which the contact bridge 140 does not interconnect the contact members 120, 130. The switch 100 is therefore open when there is no current to the solenoid actuator 700. If a voltage is applied to the winding of the coil form 710, and causes current to flow in the winding of the coil form 710, a magnetic field is formed within the solenoid actuator 700 and exerts on the guide rod 750 a force which pushes the guide rod 750 out of the region of the solenoid actuator 700 further into the contact chamber 200 against the force exerted by the return spring 740, until the contact bridge 140 comes into contact with the first contact member 120 and the second contact member 130 and thus closes the switch 100. If the supply voltage from the winding of the coil form 710 is disconnected, i.e. if the magnetic field in the solenoid actuator 700 is switched off, the return spring 740 moves the contact bridge 140 away from the contact members 120, 130 again and opens the switch 100.

FIG. 2 shows that a region, arranged between the cover disc 610 of the housing 600 and the base plate 440 of the mounting support 400, within the housing 600 is filled with a filling compound 630. The filling compound 630 may for example be an epoxy resin. The filling compound 630 fixes the first contact member 120 and the second contact member 130, on the one hand, and seals the housing 600 from the outside, on the other hand. In the drawing of FIG. 3, the filling compound 630 has not yet been filled in.

In the switch 100, the configuration of the contact chamber 200 and the mounting support 400 is particularly beneficial. This is explained in greater detail in the following description.

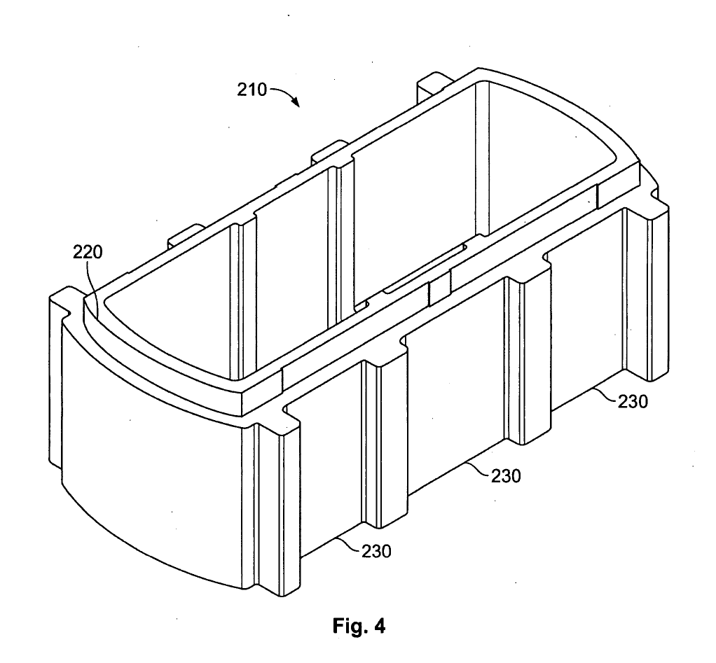

FIG. 4 is a perspective view of the base part 210 of the contact chamber 200. The base part 210 is approximately in the shape of a hollowed-out cuboid or a trough and is open at one side. The base part 210 is manufactured from a ceramic material, for example a material based on titanium oxide or aluminium oxide, and preferably produced by injection moulding. The ceramic material offers the advantage that it is not sensitive to high temperatures and arc flame impingement, does not oxidise, and has good electrical insulation properties. The aperture of the base part 210 comprises a peripheral plug 220. A plurality of recesses 230, for example three recesses 230 in each case, are arranged on the two mutually parallel longer external walls of the base part 210. The recesses 230 are provided to receive blow magnets 500, as will be explained in the following. The wall of the base part 210 opposite the aperture of the base part 210 of the contact chamber 200 comprises the first aperture 240 and the second aperture 250 through which the first contact member 120 and the second contact member 130 are guided. This cannot be seen in FIG. 4.

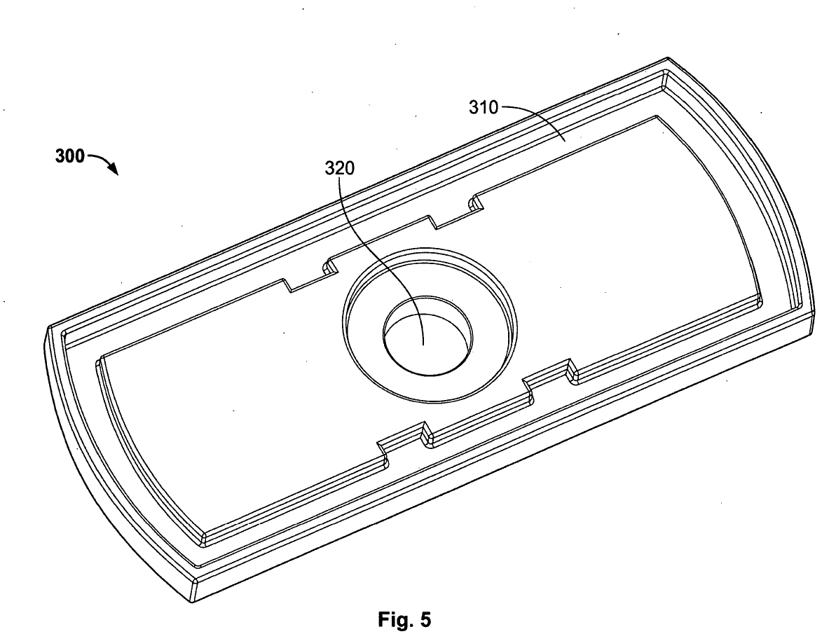

FIG. 5 is a perspective view of the cap 300 of the contact chamber 200. The cap 300 is also manufactured from a ceramic material and preferably produced by injection moulding. The cap 300 expediently consists of the same ceramic material as the base part 210 of the contact chamber 200. The cap 300 is formed approximately rectangularly and dimensioned so as to be able to seal the base part 210 of the contact chamber 200. For this purpose, the cap 300 comprises a peripheral groove 310 which can engage with the peripheral plug 220 of the base part 210 when the cap 300 is placed on the base part 210. The plug 220 and the groove 310 are formed in such a way that an increased pressure within the contact chamber 200 by comparison with the atmospheric pressure exerts on the external walls of the base part 210 a force which is transmitted to the cap 300 via the plug 220 and the groove 310, preventing damage to the base part 210. The cap 300 moreover comprises the opening 320 through which the guide rod 750 is guided.

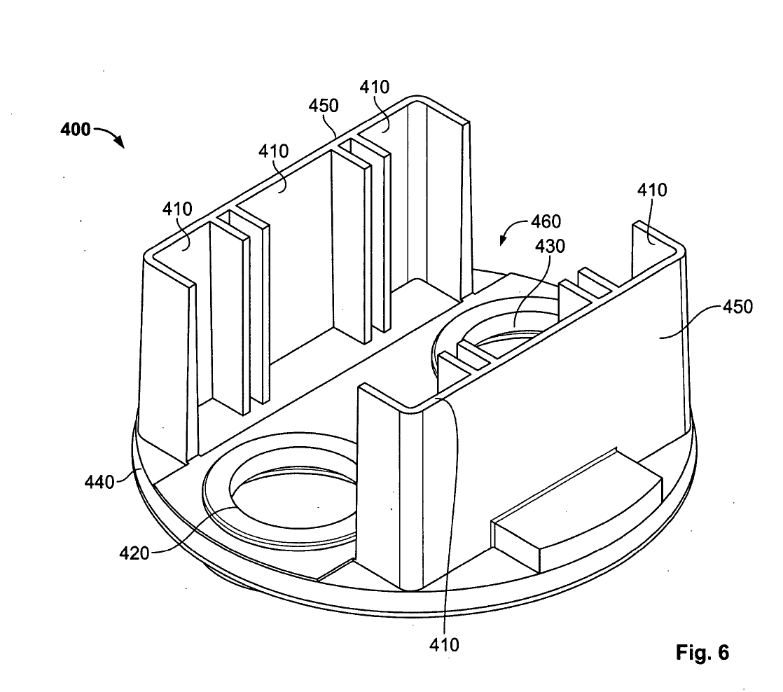

FIG. 6 is a perspective view of the mounting support 400. The mounting support 400 is manufactured from a plastics material, for example a conventional electrical engineering plastics material. The mounting support 400 is used for receiving and mounting the contact chamber 200 inside the switch 100. The use of plastics material presents the advantage that the resilient properties of the plastics material can be exploited to fix the contact chamber 200 to the mounting support 400 and to fix the mounting support 400 in the switch 100. For example, these may be fixed using press-in or snap-in connections.

The mounting support 400 comprises the aforementioned approximately circular disc-shaped base plate 440, in which the first opening 420 and the second opening 430 are arranged, through which the first contact member 120 and the second contact member 130 are guided. Two side walls 450 are placed on the base plate 440 so as to be mutually parallel and approximately perpendicular to the base plate 440. This produces a chamber receiving region 460, positioned above the openings 420, 430, between the two side walls 450. The contact chamber 200 consisting of the base part 210 and the cap 300 can be inserted into the chamber receiving region 460 in such a way that the first aperture 240 of the contact chamber 200 is arranged above the first opening 420 of the mounting support 400 and the second aperture 250 of the contact chamber 200 is arranged above the second opening 430 of the mounting support 400. The external walls, comprising the recesses 230, of the base part 210 of the contact chamber 200 thus face towards the side walls 450 of the mounting support 400. Each of the side walls 450 comprises a plurality of magnet chambers 410 which are respectively adjacent to the recesses 230 of the base part 210. In the example shown, each of the side walls 450 comprises three magnet chambers 410. A plurality of blow magnets 500 can be inserted into the hollow spaces, formed by the magnet chambers 410 and the recesses 230, between the contact chamber 200 and the mounting support 400. In the example shown, six blow magnets 500 can be inserted.

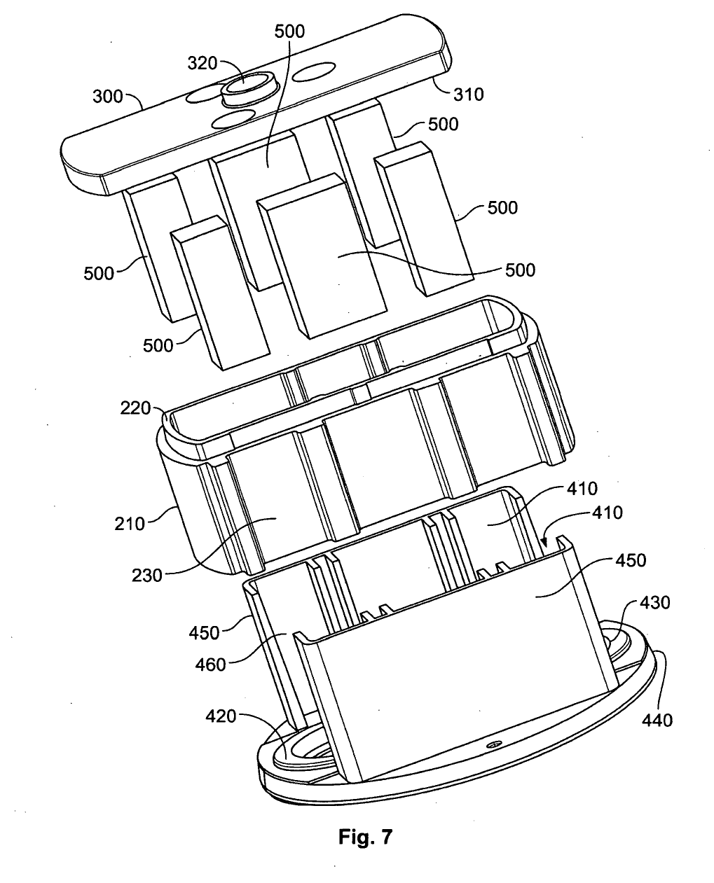

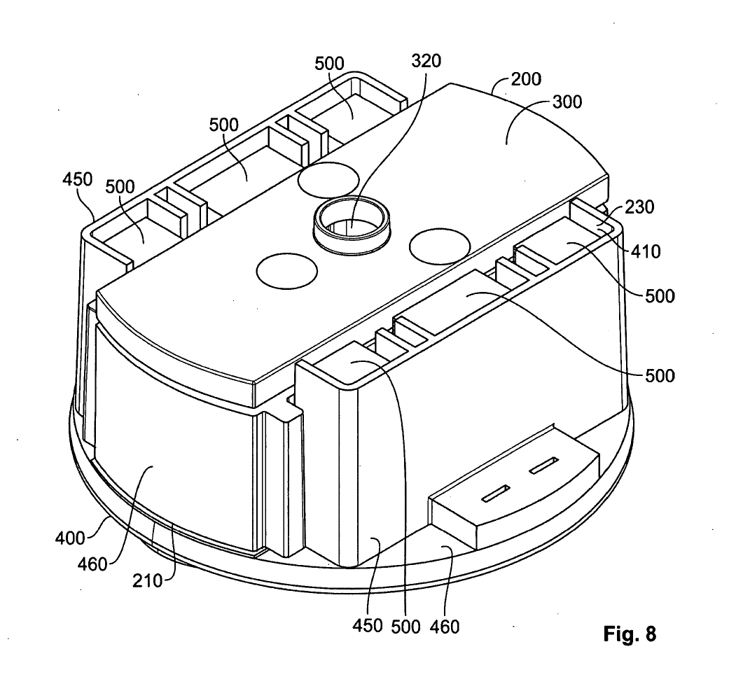

FIG. 7 is an exploded view showing that the base part 210 of the contact chamber 200 is inserted into the chamber receiving region 460 of the mounting support 400. Six blow magnets 500 are inserted into the hollow spaces, formed by the recesses 230 and the magnet chambers 410, between the mounting support 400 and the base part 210. The cap 300 seals the base part 210 of the contact chamber 200. FIG. 8 shows the contact chamber 200, the mounting support 400 and the blow magnets 500 when assembled.

When the switch 100 is opened, i.e. when the contact bridge 140 is removed from the first contact member 120 and the second contact member 130, the large currents which may be flowing through the switch 100 can result in an arc forming inside the contact chamber 200. This applies in particular when the switch 100 is used for switching an inductive load. An arc of this type may be accompanied by an extremely high temperature of for example 10,000 K and an explosive rise in pressure within the contact chamber 200. The use of a ceramic material for the contact chamber 200 offers the advantage that the contact chamber 200 is not oxidised or otherwise damaged by the arc and the high temperature. The high resistance of the ceramic material and the configuration of the base part 210 and the cap 300 with the plug 220 and the groove 310 mean that the contact chamber 200 is also not sensitive to the large rise in pressure. The filling compound 630 seals the switch 100 from the outside.

The blow magnets 500 are formed as permanent magnets and cause any arc occurring when the switch 100 is opened to be spun around by the magnetic field generated by the blow magnets 500 and thus rapidly extinguished. In an alternative embodiment, instead of the permanent magnets, electromagnets may also be used as blow magnets 500.

1. Switch for switching an electrical load, comprising a contact chamber in which a first contact member, a second contact member and a movable contact bridge are arranged, the contact chamber being arranged in a mounting support, wherein the contact chamber comprises a ceramic material and the mounting support comprises a plastics material.

2. Switch according to claim 1, wherein the contact bridge can assume a first position, in which the contact bridge conductively connects the first contact member and the second contact member, and the contact bridge can assume a second position, in which the first contact member and the second contact member are mutually electrically insulated.

3. Switch according to claim 2, wherein the switch comprises a solenoid actuator, which is configured to switch the contact bridge between the first position and the second position.

4. Switch according to claim 3, wherein the contact bridge assumes the second position when there is no current to the solenoid actuator.

5. Switch according to claim 2, wherein, in the second position, the contact bridge is not in conductive contact either with the first contact member or with the second contact member.

6. Switch according to claim 1, wherein the contact chamber comprises a first aperture and a second aperture, the first contact member extending through the first aperture and the second contact member extending through the second aperture, and in that the mounting support comprises a first opening and a second opening, the first contact member extending through the first opening and the second contact member extending through the second opening.

7. Switch according to claim 1, wherein switch comprises a housing, the mounting support and the contact chamber being arranged in the housing.

8. Switch according to claim 7, wherein a metal cup is provided in the housing, the mounting support and the contact chamber being arranged in the cup.

9. Switch according to claim 7, wherein the first contact member and the second contact member are fixed in the housing a filling compound.

10. Switch according to claim 9, wherein housing is tightly sealed by the filling compound.

11. Switch according to claim 1, wherein the contact chamber comprises a base part and a cap.

12. Switch according to claim 11, wherein the base part of the contact chamber comprises a peripheral plug, and the cap of the contact chamber comprises a peripheral groove which is engaged with the peripheral plug.

13. Switch according to claim 11, wherein the base part and/or the cap of the contact chamber are produced by injection moulding.

14. Switch according to claim 1, wherein at least one permanent magnet is arranged between the contact chamber and the mounting support.

15. Switch according to claim 14, wherein at least two permanent magnets are arranged between the contact chamber and the mounting support, the permanent magnets being mutually separated by intermediate walls at least in part.

16. Switch according to claim 1, wherein the mounting support comprises a circular disc-shaped base plate, on which two mutually parallel side walls are placed, the contact chamber being arranged in a chamber receiving region provided between the side walls.
